(19) United States
(12) Patent Application Publication
(10) Pub. No.: US 2005/0218308 A1
(43) Pub. Date: Oct. 6, 2005

(54) Electronic imagers using an absorbing filter for flare reduction

(75) Inventors: Russell J. Palum, Rochester, NY (US); Sean C. Kelly, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/812,534

(22) Filed: Mar. 30, 2004

(51) Int. Cl. H01J 40/14

(52) U.S. Cl. 250/226

(57) ABSTRACT

An image sensor includes a plurality of pixels for absorbing incident light; and an absorptive material that spans the pixels for absorbing wavelengths at a transition between a desired bandpass and rejection band.

### FIELD OF THE INVENTION

The invention relates generally to the field of image sensors and, more particularly, to image sensors having a dichroic infrared cutoff filter or a cutoff filter for any bandpass and for eliminating multiple reflections between the cover-glass and the image sensor.

### BACKGROUND OF THE INVENTION

Prior art image sensors typically have a cover-glass and a color filter array (CFA) covering the image sensor. Incoming light passes through the cover-glass and a majority of the light then passes through the CFA and into the image sensor for forming an electronic representation of an image. If the principal ray enters the cover-glass at an angle, the remaining light (typically between 10 to 50 percent) is reflected by the sensor back toward the cover-glass where it oscillates between the sensor and the cover-glass until it eventually dissipates. This causes undesirable out-of-focus images to be formed in the image sensor of the captured image. If the principal ray enters the cover glass substantially perpendicular to the sensor, the multiple reflections will cause an out-of-focus halo. It is noted that the reflections are most pronounced at the 50 percent transmission point of the dichroic.

Consequently, a need exists for an image sensor that eliminates these multiple reflections.

### SUMMARY OF THE INVENTION

The present invention is directed to overcoming one or more of the problems set forth above. Briefly summarized, according to one aspect of the present invention, the invention resides in an image sensor comprising a plurality of pixels for absorbing incident light; and a color filter array spanning the plurality of pixels having a material either integrated therein or layered thereon for absorbing wavelengths at a transition between a desired bandpass and rejection band.

These and other aspects, objects, features and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention has the advantage of eliminating multiple reflections between the cover-glass and the image sensor.

### BRIEF DESCRIPTION OF THE DRAWINGS

FIG. 1 is a side view of an image sensor of the present invention;

FIG. 2 is an alternative embodiment of FIG. 1;

FIG. 3 is a graph of absorption versus wavelength for the infrared cutoff filter;

FIG. 4 is a graph of the bandpasses for a multi-spectral imager;

FIG. 5 is an alternative embodiment of FIG. 4;

FIG. 6 is an alternative embodiment of FIG. 5; and

FIG. 7 is a camera illustrating a typical commercial embodiment for the image sensor of the present invention.

### DETAILED DESCRIPTION OF THE INVENTION

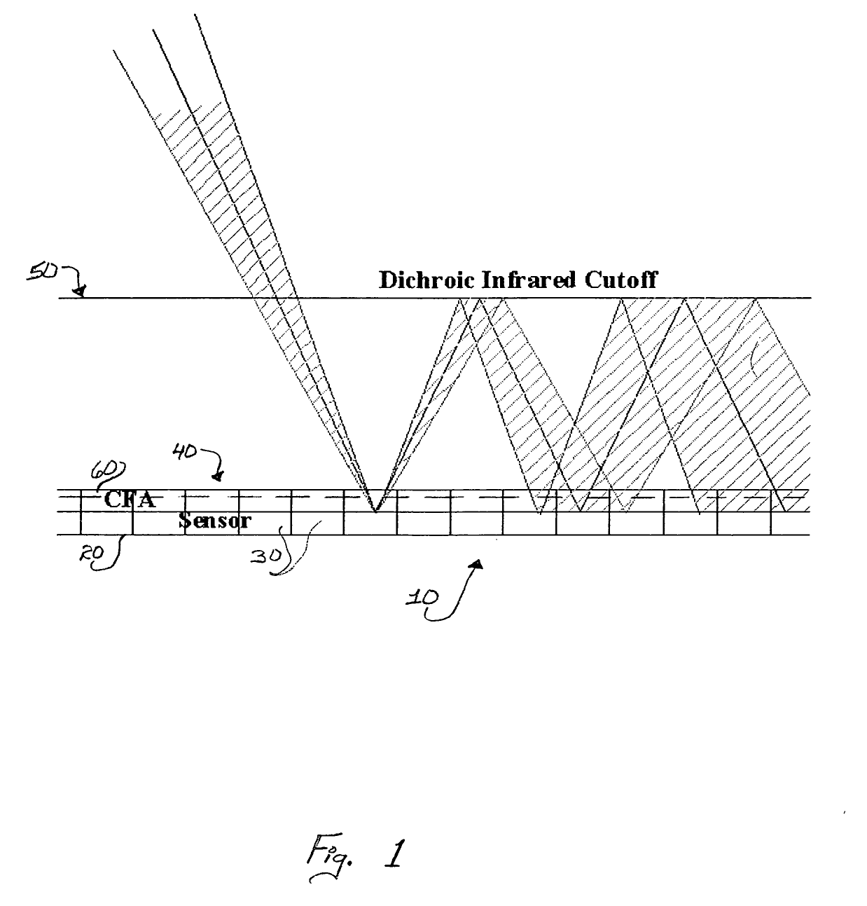

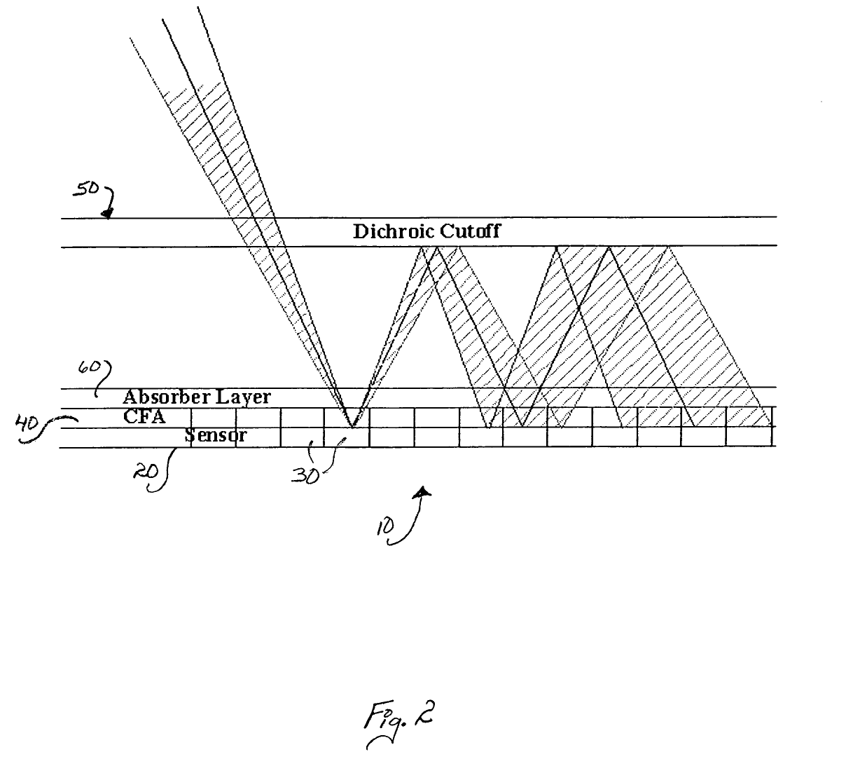

Referring to FIGS. 1 and 2, there are illustrated side views of the image sensor 10 of the present invention. The sensor 10 includes a substrate 20 and a plurality of pixels 30 spanning and covering the substrate 20. A CFA 40, which includes a plurality of different colored filters, spans and covers the pixels 30, and a cover-glass 50 (either a dichroic cutoff itself or in combination with a separate dichroic cutoff) is disposed spanning and covering the CFA 40.

An absorbing layer 60 (illustrated by the dashed lines) is disposed either in (as illustrated by FIG. 1) or layered on (as illustrated by FIG. 2) the CFA 40 for absorbing the light having multiple reflections. It is noted that the absorber 60 does not have to be highly absorptive because the image forming light only passes through the absorber 60 once, but the light forming multiple reflections passes through the absorber three times. Generally, such an absorbing layer 60 comprises a copper phthalocyanine cyan colorant. The exact material will depend on the specific IR filter and red color filter being used as those skilled in the art can readily determine.

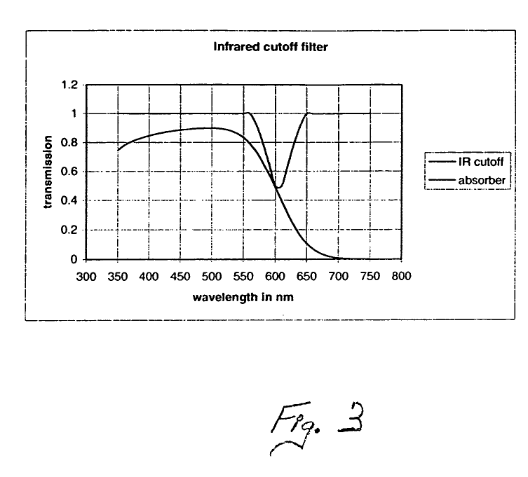

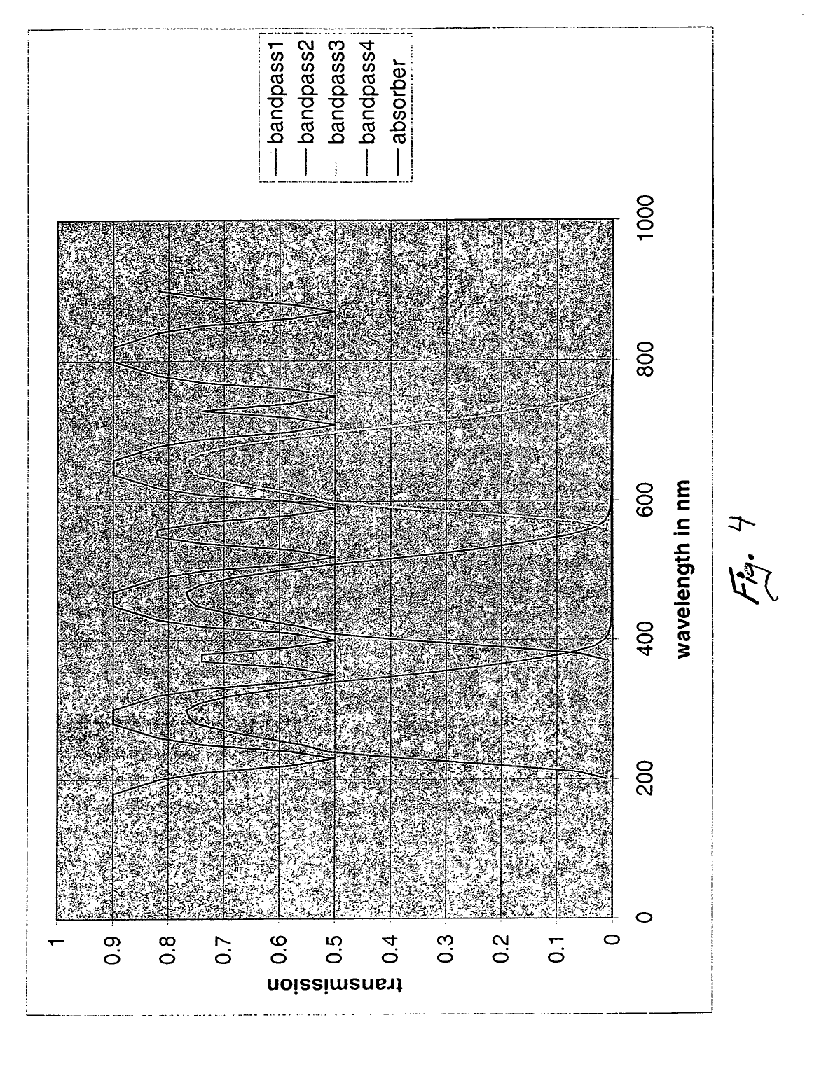

Referring to FIG. 3, there is shown a graph of absorption versus wavelength for the infrared cutoff filter. It is noted that the peak of the absorber should be at the transition between the high transmission and low transmission spectral bands with a peak at approximately the 50 percent point of the high or maximum transmission. Referring to FIG. 4, if a multi-spectral imager is used, an absorbing notch at the 50% point of each bandpass may be used to attenuate reflections. A filter that absorbs substantially equally at all wavelengths to which the sensor 10 responds could also be used in the multi-spectral case or the case where there is only one cutoff transition. This has the disadvantage compared to the preferred embodiment of a wavelength selective absorber in that the image forming light is also attenuated, but the reflections are substantially more absorbed because the image forming light only passes through the absorber once. The reflections, however, pass through the absorber three times on the first reflection and two more times for each subsequent reflection.

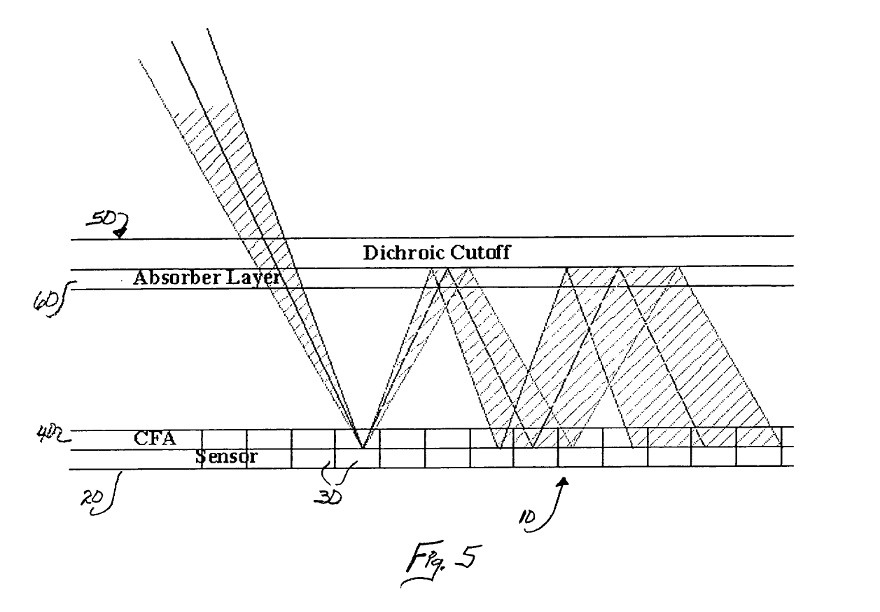

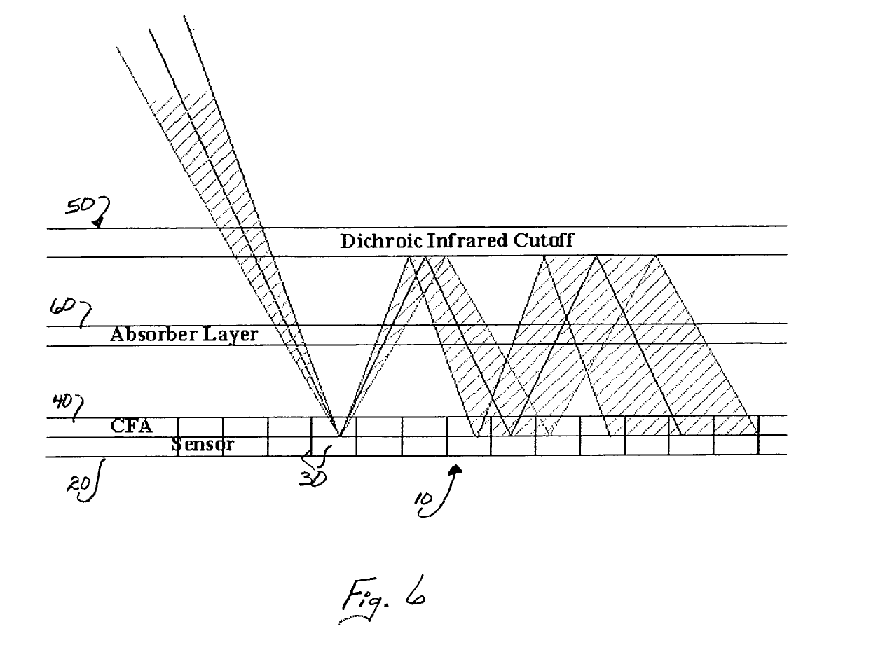

Referring to FIG. 5, there is shown an alternative embodiment of the present invention. In this embodiment, all components are arranged the same as in FIG. 1 except that the absorbing layer 60 is layered onto the cover-glass (dichroic cutoff) 50. Referring to FIG. 6, there is shown still yet another alternative embodiment of the present invention. This embodiment also the same as in FIG. 1 except that the absorbing layer 60 is disposed between the cover-glass (dichroic layer) 50 and the CFA 40. As may be apparent to those skilled in the art, it is noted that in all embodiments the CFA 40 may be omitted for capturing a monochrome image.

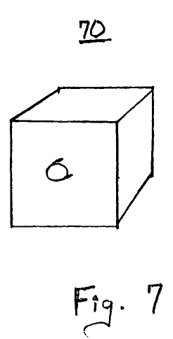

Referring to FIG. 7, there is shown a camera 70 for illustrating a typical commercial embodiment of the present invention to which the typical consumer is accustomed to purchasing.

The invention has been described with reference to a preferred embodiment. However, it will be appreciated that variations and modifications can be effected by a person of ordinary skill in the art without departing from the scope of the invention.

### PARTS LIST

10 image sensor
20 substrate
30 pixels
40 CFA
50 cover-glass
60 absorbing layer
70 camera

1. An image sensor comprising:
a) a plurality of pixels for absorbing incident light; and
b) an absorptive material spanning the pixels that absorbs wavelengths at a transition between a desired bandpass and rejection band.

2. The image sensor as in claim 1, wherein the material is a copper phthalocyanine cyan colorant.

3. The image sensor as in claim 1, wherein the transition is substantially between 600 to 700 nanometers.

4. The image sensor as in claim 1 further comprising a plurality of transitions at which there is a corresponding plurality of desired bandpass and rejection bands.

5. The image sensor as in claim 1, wherein the material absorbs substantially equally at all wavelengths.

6. The image sensor as in claim 1, wherein the absorptive material is disposed either in or on a color filter.

7. The image sensor as in claim 1, wherein the absorptive material is disposed between the image sensor and a cover-glass.

8. The image sensor as in claim 1, wherein the absorptive material is layered on a cover-glass.

9. An image sensor comprising:
a) a plurality of pixels for absorbing incident light; and
b) a material spanning the pixels that absorbs wavelengths at substantially all wavelengths to which the sensor responds.

10. The image sensor as in claim 9, wherein the material is copper phthalocyanine cyan colorant.

11. The image sensor as in claim 9, wherein the transition is substantially between 600 to 700 nanometers.

12. The image sensor as in claim 9 further comprising a plurality of transitions at which there is a corresponding plurality of desired bandpass and rejection bands.

13. The image sensor as in claim 9, wherein the absorptive material is disposed either in or on a color filter.

14. The image sensor as in claim 9, wherein the absorptive material is disposed between the image sensor and a cover-glass.

15. The image sensor as in claim 9, wherein the absorptive material is layered on a cover-glass.

16. A camera comprising:
an image sensor comprising:
a) a plurality of pixels for absorbing incident light; and
b) an absorptive material that absorbs wavelengths at a transition between a desired bandpass and rejection band.

17. The camera as in claim 16, wherein the material is a copper phthalocyanine cyan colorant.

18. The camera as in claim 16, wherein the transition is substantially between 600 to 700 nanometers.

19. The camera as in claim 16 further comprising a plurality of transitions at which there is a corresponding plurality of desired bandpass and rejection bands.

20. The camera as in claim 16, wherein the absorptive material is disposed either in or on a color filter.

21. The camera as in claim 16, wherein the absorptive material is disposed between the image sensor and a cover-glass.

22. The camera as in claim 16, wherein the absorptive material is layered on a cover-glass.

23. A camera comprising;
an image sensor comprising:
a) a plurality of pixels for absorbing incident light; and
b) an absorptive material that absorbs wavelengths at substantially all wavelengths to which the sensor responds.

24. The camera as in claim 23, wherein the material is copper phthalocyanine cyan colorant.

25. The camera as in claim 23, wherein the transition is substantially between 600 to 700 nanometers.

26. The camera as in claim 23, wherein the absorptive material is disposed either in or on a color filter.

27. The camera as in claim 23, wherein the absorptive material is disposed between the image sensor and a cover-glass.

28. The camera as in claim 23, wherein the absorptive material is layered on a cover-glass.
